(19) United States
(12) Patent Application Publication
(10) Pub. No.: US 2014/0040299 A1
(43) Pub. Date: Feb. 6, 2014

(54) Automated Method of Detecting Pattern Matches between Converged Infrastructure Models and an Operating Converged Infrastructure

(71) Applicant: Cisco Technology, Inc., San Jose, CA (US)

(72) Inventors: Raju Datla, Pleasanton, CA (US); Raju S V L N Penmetsa, San Jose, CA (US); Bhaskar Krishnamsetty, Flower Mound, TX (US); Sung-Jin Lim, Fremont, CA (US); Muralidhara SrinivasaRao Alapati, Fremont, CA (US); Parthasarathy Venkatavaradhan, Sunnyvale, CA (US)

(73) Assignee: Cisco Technology, Inc., San Jose, CA (US)

(21) Appl. No.: 13/947,341

(22) Filed: Jul. 22, 2013

Related U.S. Application Data
(60) Provisional application No. 61/679,477, filed on Aug. 3, 2012.

(51) Int. Cl. G06F 17/30

(52) U.S. Cl. CPC G06F 17/30386
USPC 707/758

(57) ABSTRACT

A first technique is provided for automatically building multiple signature patterns representative of corresponding converged infrastructures (CIs), and a second technique is provided for automatically detecting pattern matches between one or more of the multiple signature patterns (and thus the model CIs) built using the first technique and an operating converged infrastructure (CI). Each of the signature patterns includes a compilation of component signatures representative of model compute, storage, and network components of the corresponding model CI. The second technique includes collecting component signatures from, and representative of, each of compute, storage, and network components of an operating converged infrastructure (CI), and pattern matching each of the collected component signatures against one or more of the signature patterns that represent the model CIs. The second technique also includes declaring match results based on the pattern matching.

### CROSS-REFERENCE TO RELATED APPLICATION

This application claims the benefit of U.S. Provisional Application No. 61/679,477, filed Aug. 3, 2012, which is hereby incorporated by reference in its entirety.

### TECHNICAL FIELD

The present disclosure relates to automated management of converged infrastructures.

### BACKGROUND

A data center, cloud resource, or the like, may be implemented in the form of a converged infrastructure (CI). The CI is a set of integrated Information Technology (IT) components, such as storage, network, compute, and virtualization components. Typically, a user needs to build/configure the components of the CI based on a specification or plan that lists the storage, network, and compute resources required by an application, e.g., the data center or cloud resource. The specification may also be in accordance with a relatively complex CI vendor specification. Given this complexity, there is no guarantee that the CI, once configured and operating, will actually match the specification. In other words, the configured CI may not conform to the specification. Therefore, the configured CI needs to be validated against the specification to detect any such non-conformance. Conventional CI validation techniques tend to include painstaking, ad-hoc, manually-based techniques that are inefficient and that provide incomplete information regarding non-compliance.

### BRIEF DESCRIPTION OF THE DRAWINGS

FIG. 1 is a block diagram of an example converged infrastructure environment in which a converged infrastructure (CI) is configured by and operates under control of a CI controller.

FIG. 2 is a block diagram of an example CI Controller configured to perform management operations related to the CI from FIG. 1.

FIG. 3 is a flowchart that depicts a sequence of high-level operations performed by the CI controller of FIG. 2 to build CI signature patterns and detect CI signature pattern matches with respect to an operational CI.

FIG. 4 is a flowchart of example operations performed to build the CI signature patterns.

FIG. 5 is an example graphical representation useful in describing the operations performed to build multiple CI signature patterns corresponding to multiple CI models.

FIG. 6 is an illustration of a CI signature pattern representative of an example CI, which may be a model CI or an actual CI.

FIG. 7 is a flowchart of example operations performed to detect CI signature pattern matches with respect to an operating CI.

### DESCRIPTION OF EXAMPLE EMBODIMENTS

### Overview

Techniques presented herein include a first technique for automatically building multiple signature patterns representative of corresponding converged infrastructures (CIs), and a second technique for automatically detecting pattern matches between one or more of the multiple signature patterns (and thus the model CIs) built using the first technique and an operating converged infrastructure (CI).

The first technique includes identifying a component signature representative of each of compute, storage, and network model components of a corresponding model CI, wherein each component signature includes a set of descriptive features of the corresponding model component. The first technique further includes compiling the component signatures into a signature pattern representative of the corresponding model converged infrastructure. The process is repeated to produce multiple signature patterns each representative of a corresponding one of the model CIs. Finally, the first technique includes storing the multiple signature patterns in a repository.

The second technique includes collecting component signatures from, and representative of, each of compute, storage, and network components of the operating CI. The technique further includes pattern matching each of the collected component signatures (of the operating CI) against the one or more of the multiple signature patterns in the repository. The technique also includes declaring match results based on the pattern matching.

### Example Embodiments

A converged infrastructure (CI) is a modular, integrated, often pre-configured or at least easily configured, set of information technology (IT) components, typically including storage, network, compute, and virtualization components, that may be shared across multiple user applications that require storage, network, and compute resources. Due to the modular nature of the CI, the CI components made available to the user applications may be scaled up and down relatively easily and efficiently in order to accommodate corresponding increases and decreases in user application resource requirements. Examples of known converged infrastructures (CIs) include, but are not limited to, FlexPod™ by NetApp and Cisco, VSPEX by EMC, and Vblock™ by VCE. Such known CIs are configured and operated in accordance with respective vendor CI specifications that have become quasi-industry standards.

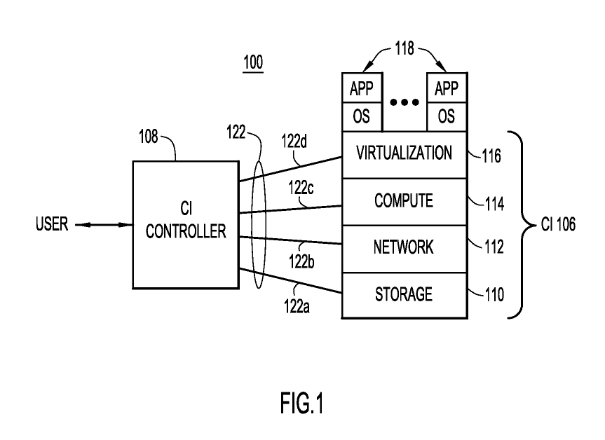

Referring first to FIG. 1, a block diagram of an example (CI) environment 100 is shown in which a CI 106 is configured by and operates under control of a CI controller 108. CI 106 includes an integrated set of components, including a storage component 110 to provide data storage, a network component 112 to provide connectivity to external devices and communication networks, a compute or server component 114 to provide processing capacity to the CI, and a virtualization component 116, such as a hypervisor, to host virtual environments. Virtualization component 116 may host multiple virtual user operating environments 118 on the stack of CI components 110, 112, and 114. Virtual user operating environments 118 may each include a virtualized operating system (OS), and one or more applications (APs) executing in the virtualized OS. Components 110, 112, and 114 provide respective data storage, network, and compute resources required by each OS and the respective one or more APs.

At a high-level, CI controller 108 serves as a unified, automated, resource configured to manage CI 106. CI controller 108 includes one or more Graphical User Interfaces (GUIs) through which a user may issue commands and provide data to the CI controller to selectively cause the controller to perform general management operations with respect to CI 106, such as to provision, configure, validate, and monitor the CI. CI controller 108 manages CI 106 over a bi-directional communication interface 122, including component interfaces 122a, 122b, 122c, and 122d each to communicate directly with a respective one of storage, network, compute, and virtualization components 110, 112, 114, and 116. Component interfaces 122a-122d may support communications in accordance with any number of different protocols, including, for example, a network protocol such as the HyperText Transfer Protocol (HTTP). To the extent that components 110-116 of CI 106 support different interface protocols, such as a Rich Text or Extensible Markup Language (XML), component interfaces 122a-122d of CI controller 108 correspondingly support the different protocols, and the CI controller may be configured to communicate with components 110-116 using different protocols to maintain interface compatibility with the components as necessary.

The provision and configure operations are performed in an initial pre-deployment phase of CI 106 to set-up/establish storage, network, compute, and virtualization components 110, 112, 114, and 116 in accordance with storage, network, compute, and virtual resource requirements of an intended operational environment. After CI 106 has been provisioned and configured, then the CI may be deployed and operated in the intended operational environment. In the operational environment, the monitor operation is performed with respect to CI 106 while the CI is operating, i.e., during run-time. The validate operation may span both the initial pre-deployment and the run-time phases. As will be described in detail below, CI controller 108 provides further management operations including operations to build CI signature patterns corresponding to CI models and to detect CI signature pattern matches with respect to CI 106 during run-time. In one embodiment, the build CI signature patterns and the detect CI signature pattern matches operations may form part of the validate operation.

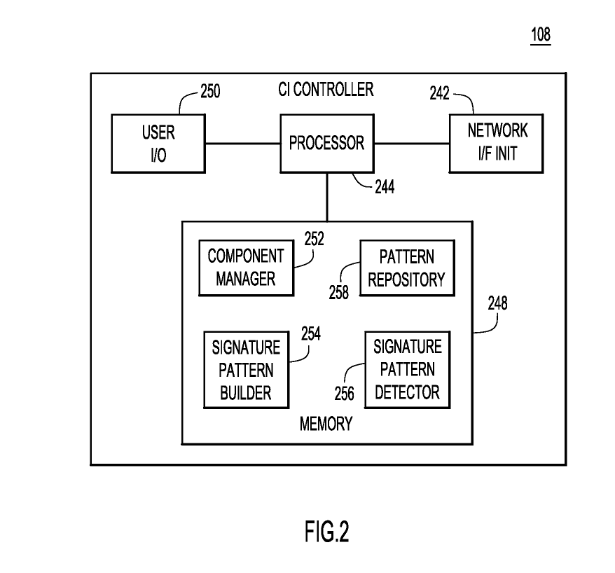

Reference is now made to FIG. 2, which shows an example block diagram of CI controller 108 configured to perform the management operations described herein, and particularly, the operations to build CI signature patterns and detect CI signature pattern matches. There are numerous possible configurations for CI controller 108 and FIG. 2 is meant to be an example. CI controller 108 includes a network interface unit 242, a processor 244, memory 248, and a user Input/Output module 250 used in association with the one or more GUIs to enable the user to interface with the CI controller. The network interface (I/F) unit 242 is, for example, an Ethernet card device that allows the CI controller 108 to connect by a wired (Ethernet) network. Network I/F 242 may also include wireless connection capability. Interface 122 (from FIG. 1) may be implemented through network I/F unit 242. The processor 244 is a microcontroller or microprocessor, for example, configured to execute software instructions stored in the memory 248.

The memory 248 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 248 may comprise one or more computer readable storage media (e.g., a memory device) encoded with software comprising computer executable instructions and when the software is executed (by the processor 244) it is operable to perform the operations described herein. For example, the memory 248 stores or is encoded with instructions for Component Manager Logic 252 to perform the generalized management operations mentioned above, CI Signature Pattern Builder Logic 254 to build CI signature patterns, and CI Signature Pattern Detector Logic 256 to detect CI signature pattern matches with respect to CI 108. In addition, the memory 248 stores CI signature patterns in a signature repository 258. GUI logic may be divided among logic units 252, 254, and 256 as necessary to support the respective logic operations.

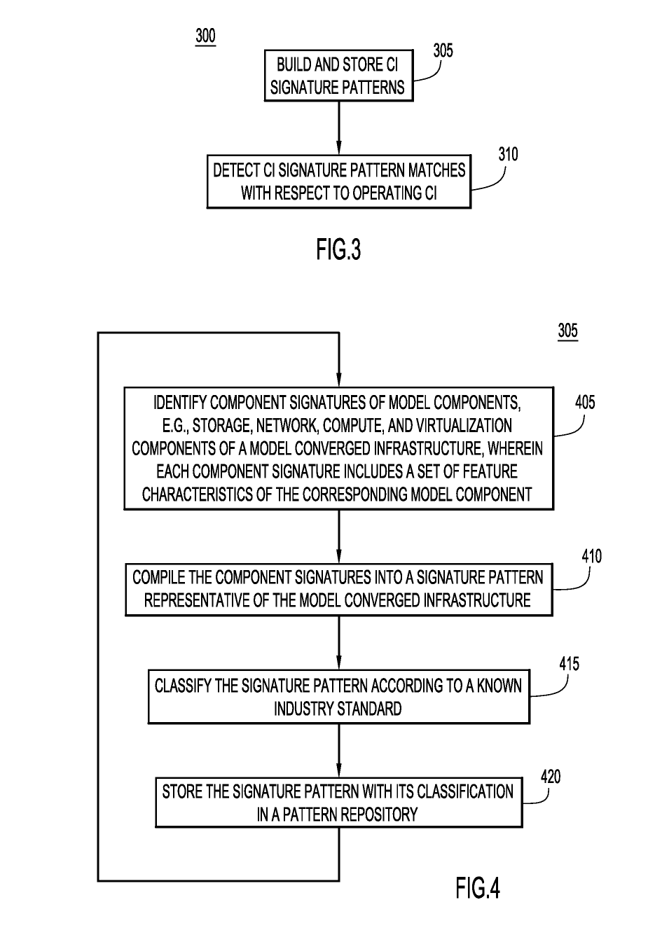

FIG. 3 is a flowchart that indicates a sequence of high-level operations 300 performed by CI controller 108, and more particularly, by CI Signature Pattern Builder Logic 254 and CI Signature Pattern Detector Logic 256.

At 305, Pattern Builder logic 254 builds, i.e., constructs, multiple CI signature patterns representative of corresponding ones of multiple CI models and stores the signature patterns in pattern repository 258. The stored signature patterns represent predetermined signature patterns to be used in the next operation 310, described below. Operation 305 is a preparatory operation that may be performed by logic 254 in isolation from an actual CI, e.g., operation 305 may be performed while CI controller 108 is disconnected from CI 106.

Operation 305 receives CI models as an input. A CI model (also referred to herein as a “model CI”) is a definition or description of a possible CI configuration that includes model CI components, such as model storage, network, compute, and optionally virtualization components. Each of the model components is itself a description of a possible CI component, and is represented as set of descriptive features that define that component, e.g., vendor, model number, etc. Therefore, a CI model and its model components are not actual, operating entities, but rather descriptions of a possible CI and its components. Therefore, the term “model” as used herein is interchangeable and synonymous with the term “data model,” i.e., a “CI model” may also be referred to as a “CI data model” and a “component model” may also be referred to as a “component data model.” The set of descriptive features that define a component (whether model or actual) are referred to as a component signature, and the collection of component signatures that collectively define a CI are referred to as a CI signature pattern (or simple as a “signature pattern”).

Operation 310 is a run-time operation. At 310, Pattern Detector logic 256 detects pattern matches between the predetermined Signature patterns (representative of the model CIs) stored in pattern repository 258 and component signatures collected from CI 106 while the CI is operating, i.e., during run time, as will be described in detail below in connection with FIG. 7. Results of operation 310 may be output to the user through a suitable GUI.

Together, operations 305 and 310 may be used to validate CI 106 against predetermined signature patterns representative of model CIs.

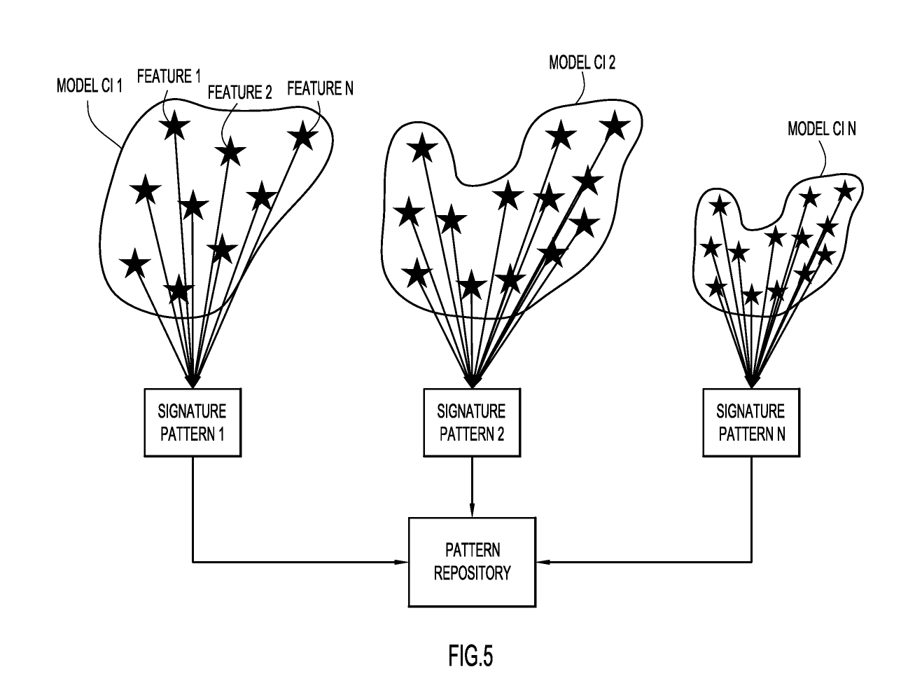

FIG. 4 is a flowchart expanding on operation 305 performed by CI Signature Pattern Builder Logic 254 to build multiple signature patterns. The flowchart of FIG. 4 is described also with reference to FIG. 5, which is a graphical representation of operations performed specifically to build multiple Signature Patterns 1-N corresponding to multiple model CIs 1-N. Therefore, the ensuing description of FIG. 4 assumes that operation 305 builds and stores Signature Patterns 1-N corresponding to model CIs 1-N, as depicted in FIG. 5.

Returning again to FIG. 4, at 405, component signatures of model components, e.g., storage, network, compute, and virtualization components, of a model CI are identified. For example, component signatures for Model CI 1 in FIG. 5 are identified. The model CI may be based on an accepted industry specification representative of known CI, such as FlexPod™, VSPEX, or Vblock™.

As mentioned above, each component signature includes a set of descriptive feature characteristics (also referred to herein as “descriptive features,” or simply “features”) of the corresponding model component. An example set of descriptive features includes, but is not limited to, one or more of the following: vendor name(s), model number, software and/or hardware version number, one or more licenses under which the component is covered, network identifiers, features supported by the component, and so on.

With reference to FIG. 5, identified component features (e.g., vendor, model no., etc.) of model components are indicated/represented as stars in each of Model CIs 1-N, see, e.g., stars labeled Feature 1 . . . Feature N in Model CI 1. At 405, the user may manually enter the identified features of the model components into CI controller 108, e.g., through a GUI. In addition, or in the alternative, CI controller 108 may automatically read the features from an input file, such as an XML file, listing the features.

Returning again to FIG. 4, at 410, CI controller 108, via logic 254, compiles the component signatures identified at 405 into a CI signature pattern representative of the model CI. For example, in FIG. 5, Features 1 . . . N of CI 1 are compiled into Signature Pattern 1. In one embodiment, the component signatures may be compiled into an XML document. At 410, logic 254 also normalizes like component signatures across all of the signature patterns.

At 415, which is optional, logic 254 classifies the signature pattern according to a known industry standard or specification descriptive of the model CI represented by the signature pattern as appropriate. This operation may include associating an industry identifier, e.g., FlexPod™, VSPEX, or Vblock™, with the signature pattern as appropriate.

At 420, the signature pattern, along with the associated classification, are stored in pattern repository 258.

CI Controller 108 repeats operations 405-420 for each model CI for which a signature pattern is to be built. For example, operations 405-420 are repeated for each of Models CI 2-N in FIG. 5 to build and store corresponding Signature Patterns 2-N.

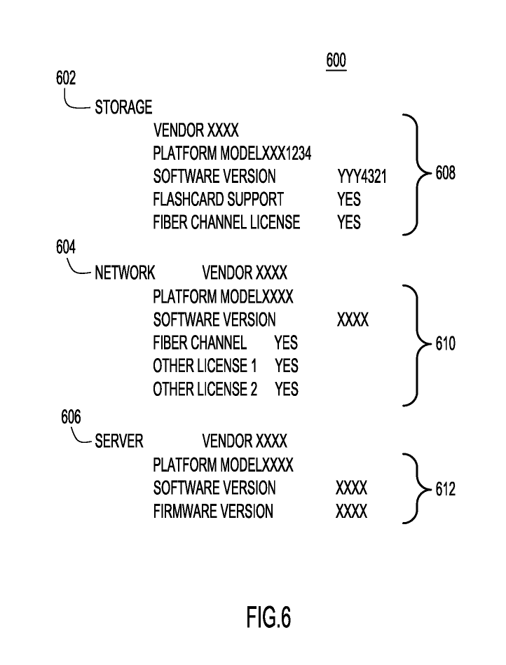

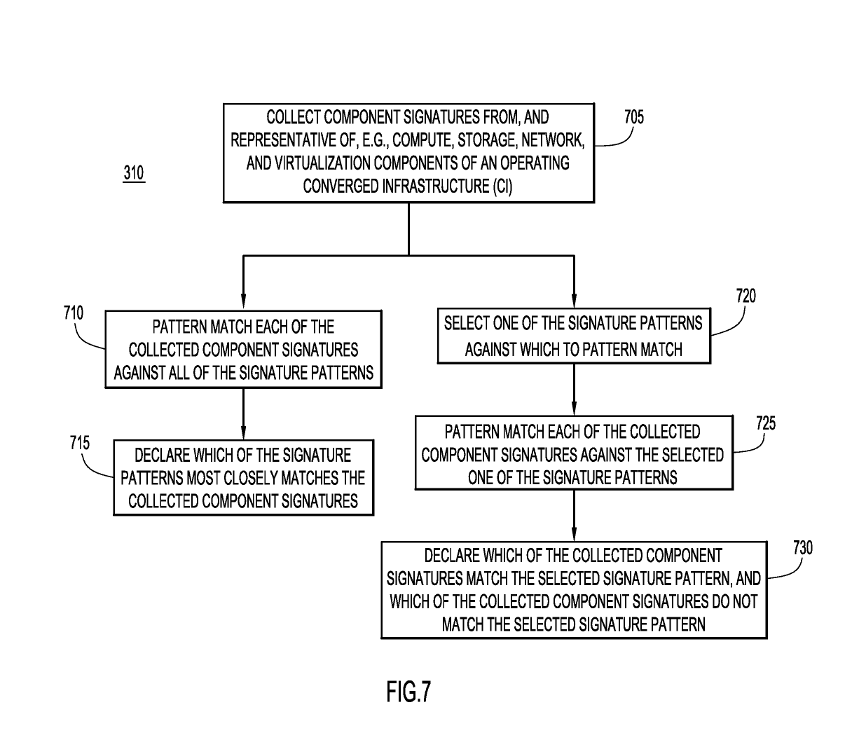

FIG. 6 is an illustration of a CI signature pattern 500 representative of an example CI. Signature pattern 600 may be used to describe a model CI or an actual CI. Signature pattern 600 includes a storage signature 602 for a storage component, a network signature 604 for a network component, and a compute or server signature 606 for a compute component. Component signatures 602, 604, and 606 include respective descriptive feature sets 608, 610, and 612.

FIG. 7 is a flowchart expanding on operation 310 performed by CI Signature Pattern Detector logic 256 to detect signature pattern matches against actual CI 106 while the CI is operating. The operations of FIG. 7 are described also with reference to FIG. 5. Operations 705-725 described below are computer implemented, i.e., automated, operations.

At 705, logic 256 collects component signatures from, and representative of, actual storage, network, compute, and virtualization components 110, 112, 114, and 116 of CI 106 over respective interfaces 122a, 122b, 122c, and 122d while the CI is operating, i.e., during run-time.

In a first embodiment of operation 310, flow proceeds from 705 to next operations 710 and 715. At 710, logic 256 pattern matches each of the collected component signatures representative of components 110-116 against all of the signature patterns, e.g., in FIG. 5, Signature Patterns 1-N, stored in pattern repository 258. The pattern matches performed at 710 determine which of stored Signature Patterns 1-N most closely matches the collected component signatures. To perform the pattern matches, logic 256 compares each of the collected component signatures to each of the compiled component signatures of the same type (i.e., of like types) in each of Signature Patterns 1-N (i.e., the collected storage component signature is compared to the compiled storage component signature, the collected network component signature is compared to the compiled network component, and so on). For each of the Signature Patterns 1-N, logic 256 tallies the compares that result in matches.

At 715, after all of the component signatures in all of the Signature Patterns 1-N have been compared against all of the collected component signatures, logic 256 declares, i.e., indicates, the Signature Pattern associated with the most matches as the winner, i.e., the winner is the Signature Pattern that most closely matches the collected component signatures of operating CI 108. If the declared winning Signature Pattern is associated with a classification, then the classification is also indicated at 715.

In a second embodiment of operation 310, flow proceeds from 705 to next operations 720, 725, and 730. In the second embodiment, the user may validate a current actual configuration of CI 106 against a particular signature pattern representative of, e.g., a known industry CI, such as FlexPod™. In the example, the user may have attempted initially to provision and configure CI 106 in accordance with the FlexPod™ specification. The user may then validate CI 106 as provisioned and configured against the FlexPod™ CI model/signature pattern (e.g., one of the predetermined Signature Patterns 1-N) during run time, as described below.

At 720, the user selects one of, e.g., Signature Patterns 1-N (e.g., FlexPod™) against which pattern matching is to be performed. Logic 256 receives the selection.

In response to the selection at 720, at 725, logic 256 pattern matches each of the collected component signatures against only the selected one of the Signature Patterns 1-N. The pattern match may be performed in substantially the same way as described in connection with operation 710.

At 730, logic 256 declares the collected component signatures that match the components of the selected Signature Pattern (e.g., the match the FlexPod™ model/signature pattern), and the collected component signatures that do not match the components of the selected Signature Pattern (e.g., do not the match the FlexPod™ model/signature pattern).

The user may use the indications from 730 as a guide to reconfigure the non-conforming components of CI 106 so they better conform to the selected CI model/Signature Pattern, and then repeat operations 725 and 730. Operations 705, 720, 725, and 730 collectively represent an automated technique to validate CI 106 against a desired (selected) model CI/signature pattern.

As described herein, a first automated technique builds signature patterns representative of CI models and a second automated technique detects pattern matches between an actual, operating CI and one or more of the signature patterns (and thus the model CIs) that were built using the first automated technique. A user may leverage the first and second automated techniques to validate an operating CI against a known industry CI specification in an accurate and efficient manner.

In summary, in one form, a method is provided, comprising: collecting component signatures from, and representative of, each of compute, storage, and network components of an operating converged infrastructure (CI); pattern matching each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and declaring match results based on the pattern matching. The collecting may include collecting from each of the components a distinct set of descriptive features representative of the component, and the component signatures representative of the model components may each include a distinct set of descriptive features representative of the model components. Each set of features may include at least two of a vendor name, a model number, and a version number. The pattern matching may include pattern matching each of the collected component signatures against all of the predetermined signature patterns, and the declaring may include declaring which of the predetermined signature patterns most closely matches the collected component signatures.

The method may further comprise, prior to the pattern matching, selecting the at least one of the predetermined signature patterns, wherein the pattern matching may include pattern matching each of the collected component signatures against only the selected at least one of the predetermined signature patterns, and the declaring may include declaring which of the collected component signatures match the selected signature pattern, and which of the collected component signatures do not match the selected signature pattern.

The method may further comprise, prior to the pattern matching, building the multiple predetermined signature patterns, wherein the building may include: identifying the component signatures of the model components of the corresponding model converged infrastructure, wherein each component signature includes a set of descriptive features of the corresponding model component; compiling the component signatures into a signature pattern representative of the corresponding model converged infrastructure; repeating the identifying and the compiling to produce the multiple signature patterns; and storing the multiple signature patterns in a repository as the predetermined signature patterns. The method may further comprise, prior to the storing, classifying each signature pattern as a known vendor provided converged infrastructure. The collecting component signatures from the operating converged infrastructure may include collecting a component signature from, and representative of, a virtualization component, and the component signatures representative of the model components may include a component signature of a model virtualization component.

In another form, an apparatus is provided, including: a network interface unit configured to send and receive communications over a network; and a processor coupled to the network interface unit, and configured to: collect component signatures from, and representative of, each of compute, storage, and network components of an operating converged infrastructure (CI); pattern match each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and declare match results based on the pattern match.

In still another form, a processor readable medium is provided, wherein the processor readable medium is for storing instructions that, when executed by a processor, cause the processor to: collect component signatures from, and representative of, each of compute, storage, and network components of an operating converged infrastructure (CI); pattern match each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and declare match results based on the pattern matching.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

What is claimed is:

1. A method, comprising:
collecting component signatures from, and representative of, each of compute, storage, and network components of an operating converged infrastructure (CI);
pattern matching each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and
declaring match results based on the pattern matching.

2. The method of claim 1, wherein:
the collecting includes collecting from each of the components a distinct set of descriptive features representative of the component; and
the component signatures representative of the model components each includes a distinct set of descriptive features representative of the model components.

3. The method of claim 2, wherein each set of features includes at least two of a vendor name, a model number, and a version number.

4. The method of claim 1, wherein:
the pattern matching includes pattern matching each of the collected component signatures against all of the predetermined signature patterns; and
the declaring includes declaring which of the predetermined signature patterns most closely matches the collected component signatures.

5. The method of claim 1, further comprising, prior to the pattern matching, selecting the at least one of the predetermined signature patterns, wherein:
the pattern matching includes pattern matching each of the collected component signatures against only the selected at least one of the predetermined signature patterns; and
the declaring includes declaring which of the collected component signatures match the selected signature pattern, and which of the collected component signatures do not match the selected signature pattern.

6. The method of claim 1, further comprising, prior to the pattern matching, building the multiple predetermined signature patterns, wherein the building includes:
identifying the component signatures of the model components of the corresponding model converged infrastructure, wherein each component signature includes a set of descriptive features of the corresponding model component;
compiling the component signatures into a signature pattern representative of the corresponding model converged infrastructure;
repeating the identifying and the compiling to produce the multiple signature patterns; and
storing the multiple signature patterns in a repository as the predetermined signature patterns.

7. The method of claim 6, further comprising, prior to the storing, classifying each signature pattern as a known vendor provided converged infrastructure.

8. The method of claim 1, wherein:
the collecting component signatures from the operating converged infrastructure includes collecting a component signature from, and representative of, a virtualization component; and
the component signatures representative of the model components include a component signature of a model virtualization component.

9. An apparatus, comprising:
a network interface unit configured to send and receive communications over a network; and
a processor coupled to the network interface unit, and configured to:
collect component signatures from, and representative of, each of compute, storage, and network components of an operating converged infrastructure (CI);
pattern match each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and
declare match results based on the pattern match.

10. The apparatus of claim 9, wherein:
the processor is further configured to collect from each of the components a distinct set of descriptive features representative of the component; and
the component signatures representative of the model components each includes a distinct set of descriptive features representative of the model components.

11. The apparatus of claim 10, wherein each set of features includes at least two of a vendor name, a model number, and a version number.

12. The apparatus of claim 9, wherein the processor is further configured to pattern match each of the collected component signatures against all of the predetermined signature patterns; and to declare which of the predetermined signature patterns most closely matches the collected component signatures.

13. The apparatus of claim 9, wherein the processor is further configured to:
prior to the pattern match operation, select the at least one of the predetermined signature patterns, to pattern match each of the collected component signatures against only the selected at least one of the predetermined signature patterns; and
declare which of the collected component signatures match the selected signature pattern, and which of the collected component signatures do not match the selected signature pattern.

14. The apparatus of claim 9, wherein the processor is further configured to, prior to the pattern match operation, build the multiple predetermined signature patterns by:
identifying the component signatures of the model components of the corresponding model converged infrastructure, wherein each component signature includes a set of descriptive features of the corresponding model component;
compiling the component signatures into a signature pattern representative of the corresponding model converged infrastructure;
repeating the identifying and the compiling operations to produce the multiple signature patterns; and
storing the multiple signature patterns in a repository as the predetermined signature patterns.

15. The apparatus of claim 14, wherein the processor is further configured to, prior to the store operation, classify each signature pattern as a known vendor provided converged infrastructure.

16. The apparatus of claim 9, wherein to collect component signatures from the operating converged infrastructure, the processor is further configured to collect a component signature from, and representative of, a virtualization component, and the component signatures representative of the model components include a component signature of a model virtualization component.

17. A processor readable medium storing instructions that, when executed by a processor, cause the processor to:
collect component signatures from, and representative of, each of compute, storage, and network components of an operating converged infrastructure (CI);
pattern match each of the collected component signatures against at least one signature pattern among multiple predetermined signature patterns that represent corresponding ones of multiple model converged infrastructures, wherein each signature pattern includes a compilation of component signatures representative of model compute, storage, and network components of the corresponding model CI; and
declare match results based on the pattern matching.

18. The processor readable medium of claim 17, wherein the instructions to cause the processor to pattern match include further instructions to cause the processor to pattern match each of the collected component signatures against all of the predetermined signature patterns; and the instructions to cause the processor to declare include further include instructions to cause the processor to declare which of the predetermined signature patterns most closely matches the collected component signatures.

19. The processor readable medium of claim 17, further comprising instructions to cause the processor to, prior to the pattern match, select the at least one of the predetermined signature patterns, wherein:
the instructions to cause the processor to pattern match include further instructions to cause the processor to pattern match each of the collected component signatures against only the selected at least one of the predetermined signature patterns; and
the instructions to cause the processor to declare include further instructions to cause the processor to declare which of the collected component signatures match the selected signature pattern, and which of the collected component signatures do not match the selected signature pattern.

20. The processor readable medium of claim 17, further comprising instructions to cause the processor to, prior to the pattern match, build the multiple predetermined signature patterns, wherein the instructions to cause the processor to build further include instructions to cause the processor to:
identify the component signatures of the model components of the corresponding model converged infrastructure, wherein each component signature includes a set of descriptive features of the corresponding model component;
compile the component signatures into a signature pattern representative of the corresponding model converged infrastructure;
repeat the identify and the compile operations to produce the multiple signature patterns; and
store the multiple signature patterns in a repository as the predetermined signature patterns.

21. The processor readable medium of claim 20, further comprising instructions to cause the processor to, prior to the store operation, classify each signature pattern as a known vendor provided converged infrastructure.

22. The processor readable medium of claim 17, wherein the instructions to cause the processor to collect component signatures from the operating converged infrastructure include further instructions to cause the processor to collect a component signature from, and representative of, a virtualization component, and the component signatures representative of the model components include a component signature of a model virtualization component.
